(19) United States
(12) Patent Application Publication
(10) Pub. No.: US 2011/0105036 A1
(43) Pub. Date: May 5, 2011

(54) METHOD AND APPARATUS FOR SENSING PRESENCE OF AN INCUMBENT SIGNAL ON A SECONDARY RADIO CHANNEL

(75) Inventors: YADUNANDANA N. RAO, SUNRISE, FL (US); APOORV CHAUDHRI, CAMBRIDGE, MA (US); SPYROS KYPEROUNTAS, WESTON, FL (US)

(73) Assignee: MOTOROLA, INC., SCHAUMBURG, IL (US)

(21) Appl. No.: 12/612,363

(22) Filed: Nov. 4, 2009

(51) Int. Cl. H04B 17/00; H04B 15/00

(52) U.S. Cl. 455/63.1; 455/67.11

(57) ABSTRACT

A remote station communicates with a base station over a secondary radio channel. During communication, the remote station determines channel conditions of the secondary radio channel. Based on the channel conditions, the remote station selects one or more sensing methods to be performed on the secondary radio channel. The result of performing the sensing method is used to determining whether an incumbent signal is present on the secondary radio channel.

### TECHNICAL FIELD

The invention relates generally to cognitive radio operation, and more particularly to ensuring that a secondary radio channel initially selected for communication is not later occupied by an incumbent signal.

### BACKGROUND

Cognitive radio operation involves a system where the radio network or a node in the network operates on frequencies that may be used by other operators, including those licensed to operate on a given frequency. Cognitive radio systems monitor their radio environment and change transmission and reception parameters as necessary to avoid interfering with licensed and other unlicensed operators. As such, one aspect of cognitive radio operation is the use of secondary channels. A secondary channel is a channel formed in a portion of spectrum generally reserved for a primary operator, but which is not utilized by a primary operator. Secondary use can also refer to use of spectrum that requires no license and is open to operators under certain restrictions which may limit transmit power, channel bandwidth, and so on. One common example of secondary use is the use of spectrum in a television channel in which no television broadcaster is operating. The unused television channel is located in spectrum that is typically reserved for licensed television broadcasters, but an unused channel may be used by secondary operators. Regulatory authorities have begun to allow secondary use of such spectrum so long as these secondary operators comply with safeguards to ensure they do not interfere with primary or incumbent signals. An incumbent signal is one which has priority over the secondary operator seeking to use the spectrum, and may be a licensed primary operator, or another secondary operator. To prevent interfering with incumbent operators, a secondary operator must test or otherwise sense a candidate channel to ensure there is no incumbent activity on the candidate channel, or sufficiently close in frequency that secondary operation on the candidate channel would cause interference. Once a candidate channel is determined to be free of any incumbent signals, the secondary operator may commence radio operation on the channel, which is then referred to as a secondary channel. Upon commencing operation on the secondary channel, the secondary operator will typically be required to periodically re-check the secondary channel to ensure it remains free of an incumbent signal.

There are numerous methods of sensing that may be performed by a secondary operator to detect an incumbent signal. However different types of incumbent signals are more easily detected with certain sensing methods. Furthermore, certain sensing methods perform better under different channel conditions. A secondary operator could simply perform a complete battery of sensing tests every time it is required to sense for incumbent signals, but that is inefficient. Therefore there is a need for a means by which a secondary operator may efficiently sense incumbent signals.

### SUMMARY

One embodiment provides a method for determining the presence of an incumbent signal on a secondary radio channel, and commences by establishing a communication link over the secondary radio channel between a remote station and a base station. The link is established by first determining that a candidate channel is free of incumbent signals. The candidate channel then becomes the secondary radio channel. The method commences by determining a channel estimate and a noise estimate of the secondary channel at the remote station, based on a signal received from the base station. Once the channel condition information is generated, the remote station selects at least one sensing method from a plurality of methods available to the remote station. The selection is determined by at least one of the channel estimate and the noise estimate. The remote station then executes or performs the sensing method and each sensing method performed provides a sensing result. The sensing results are provided to a decision block of the remote station which determines whether an incumbent signal is present on the secondary channel, based on the sensing results.

Another embodiment provides a cognitive radio apparatus, which includes a channel estimator which produces a channel estimate during radio communication with a base station from a signal received from the base station over a secondary radio channel. The channel estimate indicates a channel condition of the secondary radio channel. The cognitive radio apparatus further includes a noise estimator which produces a noise estimate of the secondary radio channel based on the signal received from the base station. The noise estimate indicates a noise condition of the secondary channel. The cognitive radio apparatus further includes a sensing method selector which selects at least one of a plurality of sensing methods available to the cognitive radio apparatus, based on the channel estimate and/or the noise estimate. A decision block evaluates a result of each of the sensing methods selected by the sensing method selector to determine whether an incumbent signal is present on the secondary radio channel.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 shows one embodiment of a schematic block diagram of a cognitive radio remote station;

FIG. 2 shows one embodiment of a system diagram of a cognitive radio system;

FIG. 3 shows one embodiment of a signal diagram of an orthogonal frequency division multiplexed signal;

FIG. 4 shows one embodiment of a functional block diagram of a cognitive radio;

FIG. 5 shows one embodiment of a table of sensing methods and criteria for selecting a particular method for use in sensing the presence of an incumbent signal in a cognitive radio system; and

FIG. 6 shows one embodiment of a flow chart diagram of a method of sensing the presence of an incumbent signal in a cognitive radio system.

The apparatus and method components have been represented where appropriate by conventional symbols in the drawings, showing only those specific details that are pertinent to understanding the embodiments shown so as not to obscure the disclosure with details that will be readily apparent to those of ordinary skill in the art having the benefit of the description herein. Other elements, such as those known to one of skill in the art, may thus be present.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

As described, a radio apparatus operating in a secondary mode of operation on a secondary channel is permitted to optimize sensing for incumbent signals while using the secondary channel, based on channel conditions, and which may further be based on other information such as the type of incumbent that may be present, and channel history. A secondary radio system generally includes a base station and one or more remote nodes. The remote nodes are radio devices that communicate with the base station via radio signals. Although referred to a secondary radio system, the system will typically also have the ability to engage in a primary communication mode on channels for which the system is licensed. Such systems use a secondary communication mode when additional communication resources (channels) are needed and all primary resources are occupied, at capacity, or otherwise unavailable. In establishing a secondary channel, the system must first find a channel that is not occupied by an incumbent. An incumbent can be either a primary operator, such as a licensed broadcaster, or some other secondary user including public safety radio operators, wireless audio equipment such as microphone devices, and others.

Once a candidate channel is found that is free of incumbents, as determined by, for example, sensing the channel and spectrum proximate to the channel, secondary operation may then commence. To assure continued non-interference with other operators, the system periodically re-scans or senses the channel to detect any incumbent signals which have priority on the channel. While operating in the secondary mode, as a remote node receives signals from its associated base station, the remote node determines channel conditions, such as fading type, fading rate, noise conditions, and so on. This information is used by the invention to select and configure one or more sensing methods from all of the available sensing methods. The remote station is provided with sensing methods for a variety of channels conditions and incumbent signal types, and selects optimal sensing methods from the available methods. The selected method or methods are then performed by the remote station, and the results are processed to determine whether an incumbent signal was detected.

Referring to FIG. 1, there is shown an embodiment of a schematic block diagram of a cognitive radio remote station 100. The remote station generally communicates with a base station to access communication system networks for communicating with other users and entities, as well as to access data services. The remote station can be either a fixed station or a mobile station. The remote station has the ability to operate according to cognitive radio principles, which allows the remote station and associated base station to operate in spectrum that may be contended, or typically reserved for licensed “primary” operators. This “secondary” operation is allowed so long as it doesn't substantially interfere with any incumbent operators, including primary operators and other secondary operators which may already be operating on a candidate frequency or which appear subsequently on the channel and have priority to use the channel.

Generally a cognitive radio station will sense various candidate frequencies for incumbent activity. Selection of a candidate frequency may be aided with information pertaining to incumbent operators in the region of the cognitive radio station. For example, unused television channels are typical candidate spectrum choices. To find an unused television channel in a given region, the cognitive radio station can access a database that indicates which television channels in the region are in use, or which channels are not in use. The cognitive radio can then select candidate frequencies and commence sensing at those frequencies to locate one or more that are suitably free of incumbent signals. The cognitive radio may then commence using these available frequencies for secondary radio channels. Once secondary operation has commenced, however, the cognitive radio system periodically re-checks the spectrum in which the secondary radio channel is located to assure continued non-interference with primary or other incumbent operators.

The remote station is a radio apparatus and includes a radio transceiver 102 which includes all necessary circuitry and components for frequency generation, filtering, modulation, demodulation, amplification, and so on, as is well known. The transceiver 102 is coupled to an antenna switch 104 which is used to switch an antenna 106 between transmit and receive paths of the transceiver 102. A baseband processor 108 generates baseband signals from digital data input to the baseband processor 108 for transmission by the remote station 100, and processes baseband signals received from the transceiver 102 to provide digital data to other components of the remote station 100. The transmit path receives one or more baseband signals from the baseband processor 108 at a modulator 110, which modulates a radio frequency carrier or carriers according to known digital modulation techniques. The modulated signal is fed to a transmitter 112 for amplification and transmission to the antenna 106 which radiates the signal. In the receive path radio signal are collected by the antenna 106 and fed to a receiver 114. The receiver 114 is frequency selective and is tuned to a desired receive frequency and bandwidth. The receiver 114 filters and amplifies received signals and feeds the received signal to a demodulator 116. The demodulator 116 produces one or more baseband signals that are provided to the baseband processor 108, as is known. The baseband processor 108 is typically implemented with a digital signal processor, which is a microprocessor that is specially designed to facilitate digital signal processing operations. As such, it can perform a wide variety of tasks.

The remote station 100 is generally controlled by a main controller 118, which is a microprocessor, and is coupled to a memory 120. Memory 120 represents a variety of memory in the device and includes read only memory (ROM), re-programmable memory, scratch pad or random access memory (RAM), and so on. The memory 120 stores instruction code which is executed by the controller 118 causing the remote station 100 to perform various tasks and operations by design. The memory 120 also allows instantiation of an operating system, applications, data structures, variables, virtual machines, and other software entities as needed. Memory components may also be used to support operation of the baseband processor 108. As is known, the memory 120 is coupled to the main controller 118 and baseband processor 108 via a bus using standard interfacing and addressing means.

The remote station 100 further comprises an audio processor 122 to facilitate voice and other audible communication. The audio processor 122 receives digital audio signals produced by the baseband processor 108 from received baseband signals, and converts the digital audio signals into analog signals that are played via a speaker 124 to produce acoustically perceivable signals. Similarly, a microphone 126 collects voice and other audible sounds as acoustic signals, producing an analog signal to the audio processor 122, which digitizes the received analog signal and provides the digital audio signal to the baseband processor 108 for transmission. The remote station 100 is operated by a user via interface elements 128, including a keypad 130 and other buttons or input components, and a graphic display 132 which displays information visually.

The remote station 100 is designed to be able to sense radio channels and detect the presence or absence of signals. Various sensing methods may be used to sense candidate channels, as well as secondary channels presently being used by the remote station 100. The sensing methods are preferably performed by the baseband processor 108 on samples taken from the receiver 114 while the receiver 114 is set or tuned to a channel of interest. The sensing methods are implemented as programmatic instruction code sets 134 stored in memory 120, for example.

To perform a given sensing method, the instruction code corresponding to the method is instantiated and executed by the baseband processor 108, or its functional equivalent. Each sensing method can have adjustable parameters or settings for thresholds, which is set in response to channel conditions. Additionally, the baseband processor 108 provides a channel estimate and a noise estimate based on signals received from a base station with which the remote station 100 is communicating.

Typically signals transmitted by the base station have reference information embedded in the information signal. The reference information may include pilot symbols, synchronization symbols, or both. The reference information is known by the remote station, and errors in receiving the reference information are used to characterize channel conditions and produce the channel estimate and noise estimate. Particularly, the channel estimate indicates the channel type, indicating the fading type and rate of fading, which are produced by movement of the remote station, as well as multipath and shadowing effects. The noise estimate indicates the general noise incident in the channel. This information is used to anticipate received signal distortion and make appropriate corrections.

Once the noise is characterized it can be accounted for while processing signals received over the channel. The channel estimate and noise estimate are used to select sensing methods to detect incumbent signals. Different sensing method perform better under different channel conditions, as well as when sensing for particular types of incumbent signals.

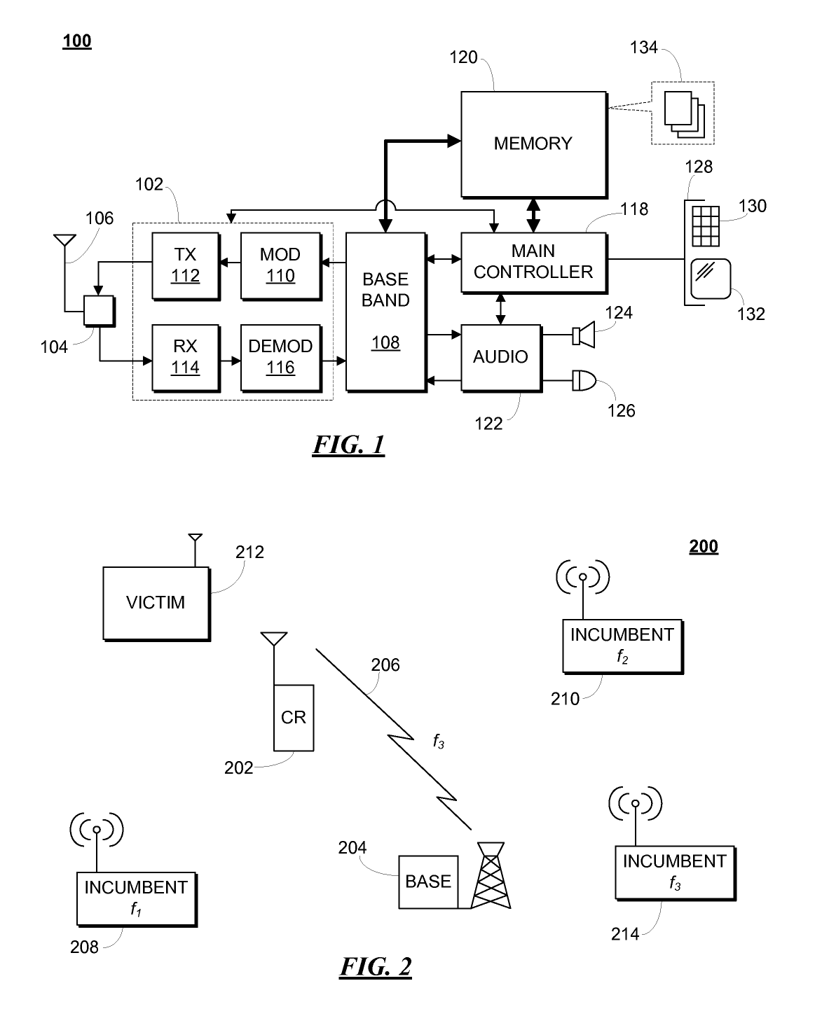

FIG. 2 shows a system diagram of a cognitive radio system 200. A cognitive radio (CR) 202 communicates with a base station 204 over a secondary radio channel 206. Preliminarily, the CR and base station may communicate over a primary channel, and subsequently decide to move to a secondary channel. To move to a secondary channel, the CR system 200 must find an available channel for secondary operation. The CR 202, as a node of the CR system 200, may be used to commence sensing various channels. For example, the CR 202 may sense a series of channels on frequencies f₁, f₂, and f₃. The CR 202 sets its receiver to the selected frequency and samples the channel at a preselected bandwidth. Upon sensing at f₁, the CR 202 detects an incumbent signal from incumbent 208 transmitting on the channel. By “on the channel” it is meant that the incumbent signal is located within the channel, overlapping the channel, or otherwise in sufficient spectral proximity to cause interference with the incumbent signal. Likewise, upon sensing at f₂, the CR 202 likewise detects a second incumbent signal from incumbent operator 210, eliminating that channel from consideration for secondary use by the CR system 200. The CR system 200 avoids any channels which, if used by the CR system 200, would interfere with reception at a victim receiver 212 of whatever signals are being transmitted to the victim receiver 212, and other such receivers. The level of permissible interference may be set, for example, by a regulatory agency such as the FCC. Finally, in the present example, the CR 202 senses at f₃, and finds no incumbent signal. Thus, the radio link between the CR 202 and the base station 204 may then commence over a secondary channel at f₃. It will be appreciated by those skilled in the art that a channel will extend out from a given frequency over a prescribed bandwidth. The frequency is simply used as a reference, such as a center frequency of the channel. In some systems the link, although referred to as being a secondary channel, may be a pair of channels, one for transmitting from the base station 204 to the remote stations, and one for remote stations to transmit to the base station 204. In such systems, of course, the CR system 200 will have to determine that both directions are clear of incumbent signals before commencing communication activity.

Upon commencing operating on a secondary channel, the CR system 200 continues to ensure that no incumbent signal is operating on the channel. One way the CR system 200 can ensure no incumbent signals are on the secondary channel is to have one or more stations, such as CR 202, commence a sensing regime in an effort to detect an incumbent. For example, after establishing the communication link 206 over a channel at f₃, another incumbent operator 214 may commence transmitting a signal on a channel including, or in sufficient spectral proximity to f₃ such that continued use of the communication link 206 by the CR system 200 could substantially interfere with signals transmitted by incumbent 214. As mentioned, there are a variety of sensing methods that may be used by a CR station to detect the presence of incumbent signals. To this end, the CR station optimizes the sensing by selecting the best method based on the channel estimate, the noise estimate, or both, and may use other information such as the type of incumbent signal likely to be detected, and a channel history, among other aiding information.

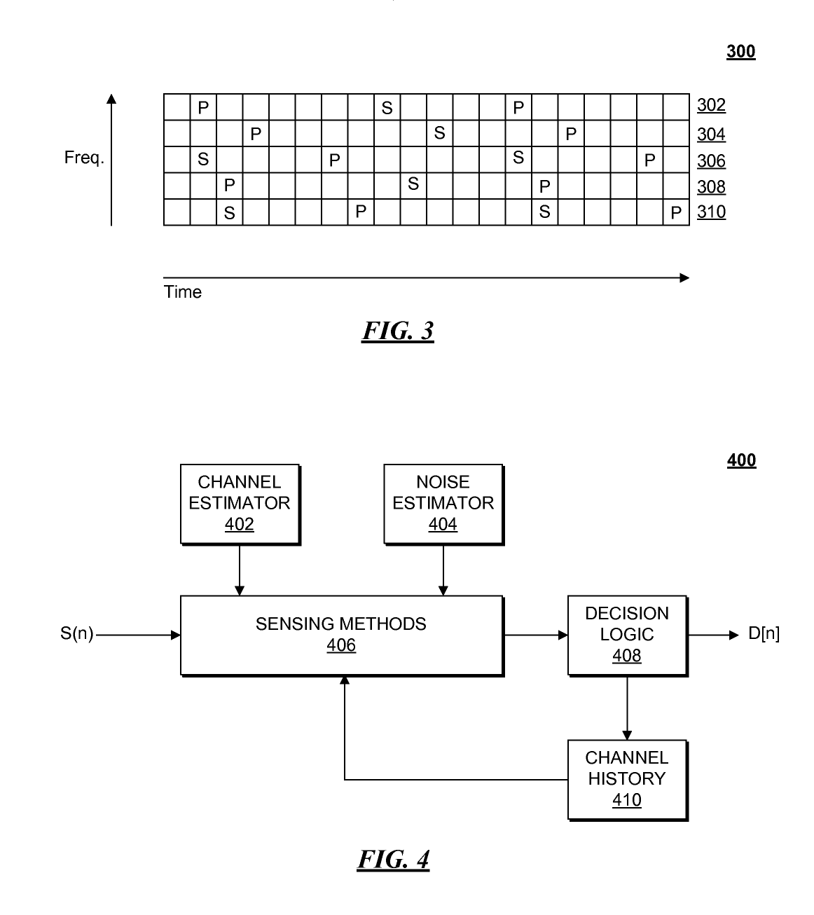

To produce the channel and noise estimates, the CR station determines errors or deviations introduced in the channel on a signal having known parameters. For example, the base station 204 can transmit a series of amplitude varying tones at different frequencies, where the amplitude variations are known (e.g., and are stored in a memory of the CR station for comparison once extracted from the signal). In digital communication systems, however, reference information is typically embedded in an information signal. An information signal is a signal that carries information intended to be rendered in some perceivable manner to a user of the communication system, such as a voice signal or a data message. The embedded reference information takes the form of pilot and synchronization (sync) symbols. As an example, FIG. 3 shows an embodiment of a signal diagram 300 of an orthogonal frequency division multiplexed (OFDM) signal. The diagram represents a symbol field transmitted over time and comprised of several subchannels 302-310 at different frequencies, typically in adjacent frequency bands. The subchannels are divided in time into symbol intervals. Each symbol interval is therefore represented by a box or square in the diagram. Most of the boxes shown are empty, and therefore available to carry a data symbol of information being transmitted to a receiver. The symbols are generally digital word segments of n bits which are mapped to a magnitude and phase constellation. At each symbol interval, the signal will have a magnitude and phase corresponding to the symbols location in the constellation, as is well known. Interspersed in the information symbols are pilot symbols P and sync symbols S. These reference symbols occur at known interval/subchannel locations in the signal, and are used by the receiving entity, which knows the reference symbol locations, to generate, among other information, the channel estimate and the noise estimate.

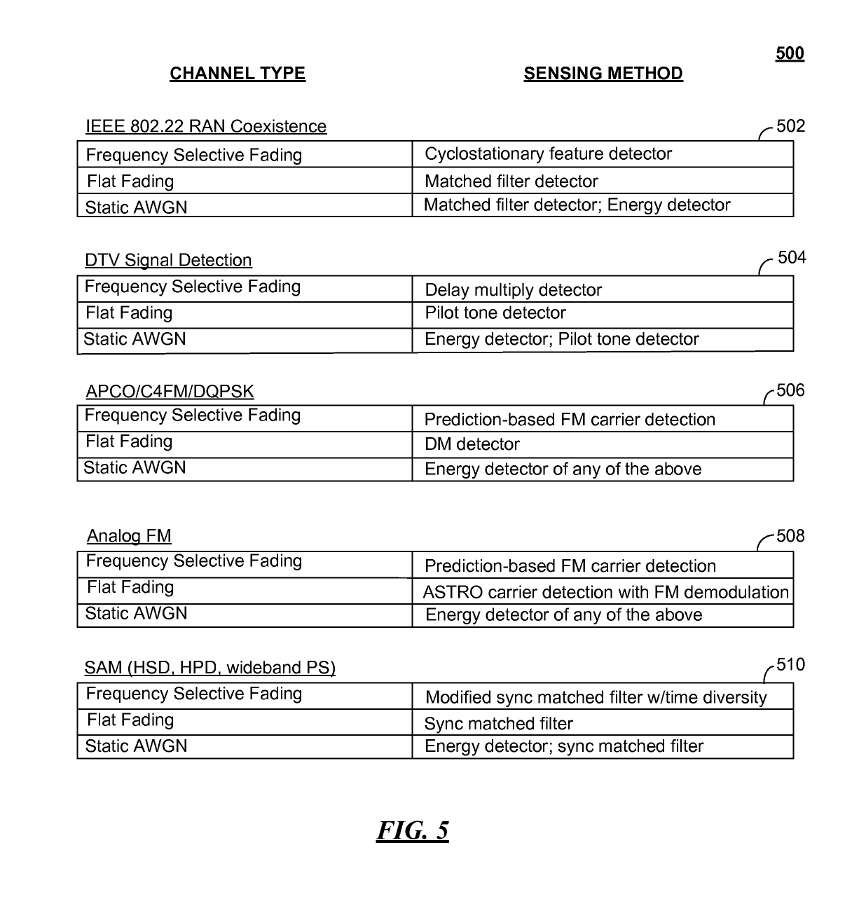

FIG. 4 shows an embodiment of a functional block diagram of a cognitive radio 400. The present diagram illustrates functional aspects of the CR 400, which may be embodied in a variety of hardware and software configurations. The CR 400 comprises a channel estimator 402 and noise estimator 404. These functions may be embodied, for example, by a baseband processor receiving reference information in a signal, such as pilot and sync symbols, and performing the necessary error determinations. The channel estimate indicates a channel type, indicating, for example, whether the channel experiences flat fading, frequency selective fading, static additive white Gaussian noise, and so on. Fading rate indicates the change in fading over time. Flat fading indicates the entire channel width, i.e. all subchannels, experience substantially the same degree of fading, whereas frequency selective fading indicates that the degree of fading is substantially different across the width of the channel. For channels that have subchannels, as in OFDM systems, each subchannel may have a different degree of fading. The noise estimate indicates a level of noise and interference in the channel.

When performing sensing methods, the fading rate may dictate the dwell or integration time of a given sensing method. That is, the sensing duration of the channel sample that is sensed. The noise estimate may be used to adjust threshold of sensing methods to account for noise and ensure that an incumbent signal is sufficiently distinct from the noise floor and other noise effects. The channel and noise estimates are provided to a sensing method selector 406, which selects one or more sensing methods, based on the channel estimate and/or the noise estimate. That is, a given sensing method may perform better than others under certain channel conditions for detecting an incumbent signal. The sensing method selector 406 may further base the sensing method selection on an expected or likely type of incumbent signal based on the secondary channels spectral location. For example, channels allocated to TV stations will most likely be transmitting analog (NTSC) or DTV signals when the station is active. Further, the above mentioned TV signals may have spectral features like pilot tones for video and audio that can be used for sensing method selection. Alternatively, the sensing method selector 406 may use the information to turn off certain sensing methods which would be least likely to detect an incumbent signal under the channel conditions. In implementation, the sensing method selector 406 is comprised of a processor that is programmed to evaluate the channel estimate, noise estimate, and/or any other parameter deemed significant, and determine which of the plurality of sensing methods available to the remote station 400 should be used, such as by, for example, a look-up table or other reference that categorizes channel conditions and indicates the preferred sensing method for various channel conditions. The methods available to the remote station 400 will generally depend on the type of remote station, but may additionally be limited by conditions such as remaining battery power of the remote station, hardware capabilities of the remote station etc.

Once one or more sensing methods are selected, and the sensing parameters set based on, for example, the channel fading rate and the noise estimate, the sensing methods are performed on a sample signal S(n), producing sensing results. The sensing results are provided to a decision block 408. The decision block 408 comprises logic, such as rules implemented in software, and evaluates the sensing results against confidence criteria to produce a decision D[n], indicating whether an incumbent has been detected or not. When two or more sensing methods are used, the results of the methods may be compared using various processes, such as a logical OR comparison. Using an OR comparison, if any one sensing method indicates an incumbent is present, then the output of the decision block will indicate an incumbent signal is present. Alternatively, some statistical processing may be used, such as Bayesian combining, to determine whether the sensing results indicate an incumbent signal is present on the secondary channel being used by the CR system. In one example, if several sensing methods are used, a simple majority may be used to determine that an incumbent signal is present. The decision logic can also be used to produce a channel history 410, which can also be used in the process of selecting sensing methods.

FIG. 5 shows an embodiment of a table 500 of sensing methods and criteria for selecting a particular method for use in sensing the presence of an incumbent signal in a cognitive radio system. The table is an example of how sensing methods may be selected based on the channel estimate, noise estimate, and the type of incumbent signal thought to be present or likely present on the secondary radio channel, and may be implemented as a searchable record or look-up table in the memory of a CR device. In the present example the table has entries for five types of incumbent signals. A first type of incumbent is one complying with IEEE specification 802.22 for regional access networks (RAN) 502. A second type of incumbent is digital television signals 504. A third type of incumbent is of the type specified by the Association of Public-Safety Communication (APCO) standard, including constant envelope 4-level FM (C4FM), and differential quadrature phase shift keying (DQPSK) 506. A fourth type of incumbent is analog frequency modulation 508. And a fifth type of incumbent is scalable adaptive modulation (SAM), which includes High Speed Data (HSD), high performance data (HPD), and wideband public safety (510). For each of these incumbent signal types, the table has three different channel types; frequency selective fading, flat fading, and static additive Gaussian white noise (AWGN).

For each channel type, one or more sensing methods are listed. For example, if the CR station is on a frequency typically reserved for digital television, and the channel type corresponds to static AWGN, then an energy detector sensing method and a pilot tone detection sensing method are selected, and subsequently performed by the CR station. For each case of likely incumbent and channel type, one or more preferred sensing methods are listed. Each type of sensing method listed in the table is available to the CR station, for example as a programmatic instruction code set stored in memory of the CR station which causes the processor that executes the method to acquire and process data from a signal sample. The signal sample may be taken from the secondary radio channel during a time when the base station is not transmitting on the secondary radio channel, known as in-band sampling. The CR station can also perform out-of-band sampling by changing the receive frequency of its receiver to another channel frequency.

For example, if the secondary radio channel is in a spectrum region reserved for digital television broadcast, when flat fading is indicated, a pilot tone detection sensing method is preferred. The pilot tone of a digital television signal occurs at a specific location within the digital television channel, and if the secondary radio channel bandwidth does not include the frequency location where the pilot tone would be located, then the CR station may change its receiver frequency to the frequency where the pilot tone would be if there is a digital television signal present in the DTV channel where the secondary radio channel is located. Once the receiver frequency is adjusted, the pilot tone sensing method is then performed, and the results are then analyzed to determine if a pilot tone was detected. The CR station then returns its receiver to the secondary channel and either commences normal communication activity or informs the base station is a pilot tone was detected, indicating an DTV incumbent signal is present on the secondary channel. It is contemplated that in certain situations it is preferable to search for multiple types of incumbent signals. For example, the secondary radio channel may be located in a DTV channel, but other secondary operators may also be located in such television white spaces. So, in addition to sensing for a DTV signal, the CR station will also sense for another CR system complying with IEEE specification 802.22. In such a case, for example, given flat fading channel conditions, the CR station will use a pilot tone detection sensing method a matched filter sensing method.

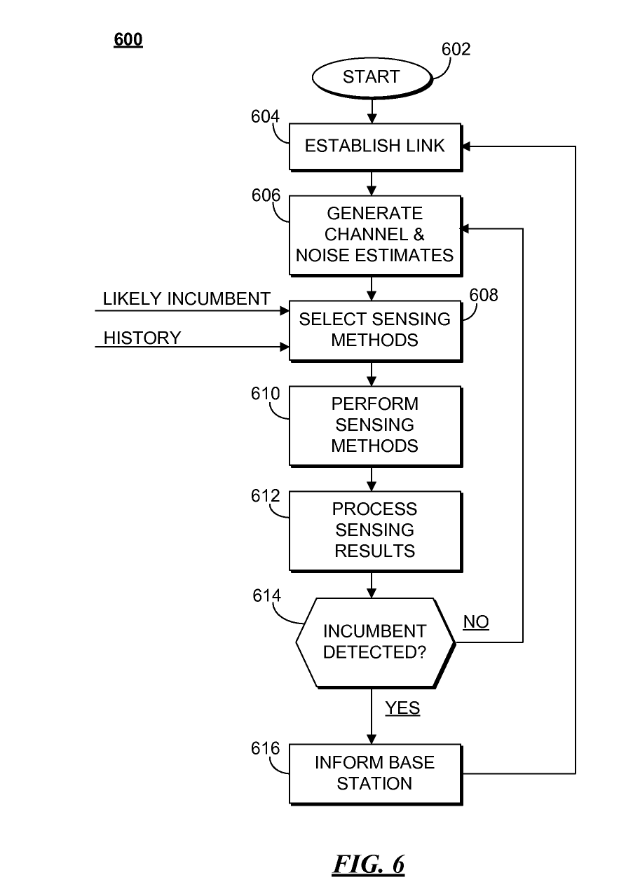

FIG. 6 shows a flow chart diagram of an embodiment of a method 600 of sensing the presence of an incumbent signal in a cognitive radio system. At the start 602 a base station is established and operating along with one or more CR remote stations. First, the CR system locates a suitable secondary radio channel. As a secondary channel, the channel location is not located at a spectral location where it will interfere with primary operators, who have a right to use the channel, such as licensed broadcasters. Furthermore, it is desirable to avoid interfering with incumbent secondary operators that are already operating. Accordingly, the CR system may examine multiple candidate channels, and may use aiding information such a location database that indicates available broadcast channels in the region of the CR system.

Once a candidate channel is found that appears to be clear of any incumbent signals, the CR remote station and base station establish a communication link 604 over the secondary radio channel and then commence communication activity as desired or necessary. In the course of regular communication activity the remote station will receive signals from the base station. The remote station will determine a channel estimate and noise estimate from the received signal 606. Once the channel and noise estimates are determined, at least one of these estimates, if not both, are then used as a basis to select at least one sensing method from the plurality of sensing methods available to the remote station 608.

The selection of sensing methods may further be based on one or more likely incumbent signal types, depending on the spectral location of the secondary radio channel. Furthermore, the selection of sensing method may further be based on a channel history maintained by the remote station. The channel history may indicate, for example, that a particular type of incumbent signal was previously detected, even though none was detected in establishing the communication link, or that it was not sufficiently strong to indicate an interference issue when previously detected. Furthermore, the previous channel conditions may be recorded and used to select a sensing method presently. For example, if the present channel conditions indicate flat fading, but on one or more previous iterations of the method the channel condition indicated frequency-selective fading, then sensing methods for both flat fading and frequency selective fading may be selected. The previous iterations used can be either or both time-based, e.g., over the previous several milliseconds, or, as certain incumbent or secondary signals are present only at predetermined time periods, can be period-based using previous similar time periods over the last several days or weeks. One such example of the latter are wireless microphones used in concerts, which may occur during evening hours, or church services, which occur most frequently on Sunday mornings.

Once the sensing methods are selected, such as by consulting a table similar to that shown in FIG. 5 for example, the sensing methods are then performed 610. Each sensing method, once performed, produces sensing results, which are processed 612 by decision logic. The sensing results may be either binary (incumbent detected or not), or they may be numerical or statistical such that they can be evaluated against adaptive thresholds, or against the results of other sensing methods, and so on. Upon processing the sensing results, a decision is made as to whether or not an incumbent signal has been detected 614 on the secondary radio channel over which the remote station and base station are presently operating. If no incumbent signal is detected, the method commences producing a next set of channel and noise estimates 606 at a predetermined amount of time later (e.g., every few minutes). If an incumbent is detected, then the remote station commences notifying the base station 616, and the base station and remote station must than find another secondary channel over which to establish a communication link 604. This other secondary channel may have previously been selected, using a similar method operating in parallel with that of the channel now found to have incumbent transmission, and stored in memory of the CR device and base station to permit immediate switching.

An alternative approach is to use all sensing methods that have a substantial likelihood of detecting an incumbent signal, and turning off/not employing those methods which, as indicated by the channel conditions, do not have a substantial likelihood of detecting incumbent signals. As used herein, a substantial likelihood implies a detection probability of greater than about 90% with a false alarm probability of less than about 10% given a fixed detector dwell time. Using this alternative method, all methods are assumed to be used at the outset, and as the cognitive radio develops channel and noise estimates, the cognitive radio selectively disables sensing methods that will not be useful in sensing incumbent signals. This approach provides a higher likelihood of detecting incumbent signals, especially if there is no particular type of incumbent expected, yet by disabling sensing methods which are known to be ineffective for a given channel condition the cognitive radio can conserve battery power.

Thus, in one embodiment only a limited number of sensing methods of all of the available sensing methods are selected and then employed. The number and/or type of sensing methods selected may change from time to time during subsequent sensing periods dependent on, e.g., current channel conditions and historical incumbent signals detected. In other embodiments, periodically all of the sensing methods may be selected and then, as above, the less-useful sensing methods may be selectively disabled over one or more iterations of sensing.

The computer program product may include a series of computer instructions fixed either on a tangible medium, such as a computer readable medium (e.g., flash memory, CD-ROM, ROM, fixed disk). The medium may be a tangible medium (e.g., optical or analog communications lines). The series of computer instructions embodies all or part of the functionality previously described herein with respect to the device. It should appreciate that such computer instructions can be written in a number of programming languages for use with many device architectures or operating systems. Furthermore, such instructions may be stored in any memory device, such as semiconductor, magnetic, optical or other memory. It is expected that such a computer program product may be distributed as a removable medium with accompanying printed or electronic documentation (e.g., shrink wrapped software) or preloaded with a device (e.g., on system ROM or fixed disk).

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Those skilled in the art will recognize that a wide variety of modifications, alterations, and combinations can be made with respect to the above described embodiments without departing from the spirit and scope of the invention defined by the claims, and that such modifications, alterations, and combinations are to be viewed as being within the scope of the inventive concept. Thus, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by any claims issuing from this application and all equivalents of those issued claims.

1. A method for determining the presence of an incumbent signal on a secondary radio channel, the method comprising:
establishing a communication link over the secondary radio channel between a remote station and a base station;
determining a channel estimate and a noise estimate of the secondary channel at the remote station based on a signal received from the base station;
selecting at least one of a plurality of sensing methods available to the remote station, wherein the selecting is determined by at least one of the channel estimate and the noise estimate;
performing the at least one of the sensing methods by the remote station, wherein each of the at least one of the sensing methods provides a result;
providing the result of the at least one of the sensing methods to a decision block of the remote station; and
determining at the decision block whether an incumbent signal is present on the secondary channel based on the result of the at least one of the sensing methods.

2. The method of claim 1, further comprising, prior to establishing the communication link between the remote station and the base station, determining that the secondary radio channel is available and free of an existing incumbent signal.

3. The method of claim 1, wherein selecting at least one sensing method further comprises determining a likely incumbent signal type, and wherein the selecting is further based on the likely incumbent signal type.

4. The method of claim 1, wherein the channel estimation determines a type of fading and a rate of fading in the secondary radio channel, and wherein selecting the at least one of the sensing methods is based on the fading type, and a sensing duration is selected based on the fading rate.

5. The method of claim 1, wherein at least one sensing threshold of the at least one of the sensing methods is based on the noise estimate, the at least one sensing threshold set to ensure that a detected incumbent signal is sufficiently distinct from a noise floor.

6. The method of claim 1, wherein the decision block compares the results of the sensing methods when at least two sensing methods are used to determine whether the incumbent signal is present.

7. The method of claim 6, wherein the results of the at least two sensing methods are combined using a Bayesian combining process to indicate whether the incumbent signal is present.

8. The method of claim 6, wherein the decision block determines that the incumbent signal is present if any of the at least two sensing methods indicates that the incumbent signal is present.

9. The method of claim 1, wherein selecting at least one sensing method is further performed based on a channel history that includes the previously-detected presence of a particular type of incumbent signal.

10. The method of claim 9, wherein selecting at least one of a plurality of sensing methods comprises using all sensing methods that have a substantial likelihood of detecting the incumbent signal and proceeding to turn off those methods which, as indicated by the at least one of the channel estimate and the noise estimate, do not have a sufficient likelihood of detecting incumbent signals.

11. A cognitive radio apparatus, comprising:
a channel estimator which produces a channel estimate during radio communication with a base station from a signal received from the base station over a secondary radio channel, the channel estimate indicating a channel condition of the secondary radio channel;
a noise estimator which produces a noise estimate of the secondary radio channel based on the signal received from the base station, the noise estimate indicating a noise condition of the secondary channel;
a sensing method selector which selects at least one of a plurality of sensing methods available to the cognitive radio apparatus based on at least one of the channel estimate and the noise estimate; and
a decision block which evaluates a result of each of the at least one of the sensing methods selected by the sensing method selector to determine whether an incumbent signal is present on the secondary radio channel.

12. The cognitive radio apparatus of claim 11, wherein each of the plurality of sensing methods are stored as programmatic instruction sets in a memory of the cognitive radio apparatus, and executed by the cognitive radio apparatus when performing each of the at least one of the sensing methods selected by the sensing method selector.

13. The cognitive radio apparatus of claim 11, wherein the sensing method selector further selects the at least one of the sensing methods based on a likely type of incumbent for the secondary radio channel.

14. The cognitive radio apparatus of claim 11, wherein the sensing method selector further selects the at least one of the sensing methods based on a channel history for the secondary radio channel, wherein the channel history includes the previously-detected presence of a particular type of incumbent signal.

15. The cognitive radio apparatus of claim 11, wherein the channel estimator produces a fading type parameter and a fading rate parameter and the sensing method selector selects the at least one of the sensing methods based on the fading type, and sets a sensing duration based on the fading rate.

16. The cognitive radio apparatus of claim 11, wherein the noise estimate determines a sensing threshold of the at least one of the sensing methods, the sensing threshold set to ensure that a detected incumbent signal is sufficiently distinct from a noise floor.

17. The cognitive radio apparatus of claim 11, wherein the decision block compares the results of the sensing methods when at least two sensing methods are used to determine whether there is an incumbent signal present.

18. A method for determining whether a secondary radio channel has become occupied by an incumbent signal, the method comprising:
establishing a communication link between a mobile station and a base station over the secondary radio channel after an initial determination that the secondary radio channel is free of an incumbent signal;
receiving an information signal at the mobile station from the base station, the information signal including information being rendered in a manner perceivable by a user of the mobile station, the information signal further including reference information embedded in the information signal;
determining a channel estimate of the secondary radio channel based on the reference information embedded in the information signal, the channel estimate indicating a fading type and a fading rate of the secondary radio channel;
determining a noise estimate of the secondary radio channel based on the information signal;
determining a likely incumbent signal type based on a spectral location of the secondary radio channel;
selecting at least one sensing method from a plurality of sensing methods available to the mobile station, based on the fading type channel estimate, noise estimate, and likely incumbent signal type, including configuring parameters of the at least one sensing method based on the channel estimation and noise estimation;
performing the at least one sensing method on a received sample of the secondary radio channel when the mobile station is not receiving a signal from the base station on the secondary radio channel to produce a sensing result for each of the at least one sensing method; and
determining whether an incumbent signal is present on the secondary radio channel based on the sensing result of each of the at least one sensing method.

19. The method of claim 18, further comprising setting a sensing time for the at least one sensing method based on the fading rate of the channel estimate.

20. The method of claim 18, wherein:
selecting at least one sensing method comprises selecting at least two sensing methods, each of the at least two sensing methods producing sensing results for each of the at least two sensing methods; and
determining whether an incumbent signal is present on the secondary radio channel is performed by applying decision logic to the sensing results to determine if the sensing results indicate the incumbent signal is present on the secondary radio channel.
